(19) United States
(12) Patent Application Publication
(10) Pub. No.: US 2022/0024145 A1
(43) Pub. Date: Jan. 27, 2022

(54) INFRARED WELDING MACHINE

(71) Applicant: TOYOTA JIDOSHA KABUSHIKI KAISHA, Toyota-shi (JP)

(72) Inventors: Masayuki ITSUNO, Toyota-shi (JP); Xiao LIU, Toyota-shi (JP); Naoki TSUZUKI, Toyota-shi (JP)

(73) Assignee: TOYOTA JIDOSHA KABUSHIKI KAISHA, Toyota-shi (JP)

(21) Appl. No.: 17/321,727

(22) Filed: May 17, 2021

(30) Foreign Application Priority Data
Jul. 27, 2020 (JP) 2020-126247

(51) Int. Cl. B29C 65/14; H05B 3/00; B29C 65/00; B29C 65/78; G02B 5/08

(52) U.S. Cl. CPC B29C 65/1412; H05B 3/0057; B29C 66/1142; H05B 2203/032; B29C 65/7802; G02B 5/0808; B29C 66/5261

(57) ABSTRACT

An infrared welding machine has a heating device that heats and melts at least one of an end surface of a first member made of resin and an end surface of a second member made of resin, called a surface-to-be-heated, with infrared rays. The heating device includes: a lamp that is disposed so as to face the surface-to-be-heated without coming into contact with the surface-to-be-heated and has a circular shape in cross-section such that the lamp radiates infrared rays in all radially outward directions; an upper-side reflective member that reflects infrared rays radiated from the lamp toward the upper side of the surface-to-be-heated so as to direct the infrared rays toward the surface-to-be-heated; and a lower-side reflective member that reflects infrared rays radiated from the lamp toward the lower side of the surface-to-be-heated so as to direct the infrared rays toward the surface-to-be-heated.

### CROSS-REFERENCE TO RELATED APPLICATION

This application claims priority to Japanese Patent Application No. 2020-126247 filed on Jul. 27, 2020, incorporated herein by reference in its entirety.

### BACKGROUND

### 1. Technical Field

The present disclosure relates to an infrared welding machine that joins end surfaces of first and second members made of resin together.

### 2. Description of Related Art

A butt welding device shown in Japanese Unexamined Patent Application Publication (Translation of PCT Application) No. 09 502405 (JP 09 502405 A), for example, is configured to join two plastic pipes together by heating and melting their end surfaces with a heating device and then butting and pressing these end surfaces together.

This heating device has a fixed plate formed by a disc that has heat-resisting and electrically insulating properties, spiral or annular resistance heating elements that are mounted on both sides of the fixed plate, and a cylindrical casing element and protective plates that cover and surround the fixed plate and the resistance heating elements.

The resistance heating elements have a flat shape, and the protective plates are made of an infrared-transmitting glass-ceramic material.

The plastic container sealing method shown in Japanese Patent No.

5768469 joins a container main body and a lid member together by heating and melting a joint surface of the container main body or a joint surface of the lid member with an infrared heater and then placing the joint surface of the lid member on the joint surface of the container main body so as to fuse these joint surfaces together.

This literature mentions focusing infrared rays radiated from the infrared heater at one point in a surface-to-be-heated with a reflective member, and also mentions collimating infrared rays radiated from the infrared heater with a reflective member so as to be applied to the surface-to-be-heated in the form of a homogeneous plane.

### SUMMARY

In JP-A-09-502405, only infrared rays radiated from a region of each resistance heating element that directly faces the end surface is applied to the end surface, and thus not all infrared rays radiated from the resistance heating element are applied to the end surface. Therefore, the heating efficiency is poor and it may take a longer time to heat and melt the entire region of each end surface.

When infrared rays are focused at one point in Japanese Patent No. 5768469, it may take a longer time to apply infrared rays to the entire region of the joint surface.

Further, when infrared rays parallel to one another are applied in Japanese Patent No. 5768469, it may take a longer time to heat and melt the entire region of the joint surface due to the lower heating energy per unit area.

In view of these circumstances, the present disclosure aims to provide an infrared welding machine that can evenly and quickly melt the entire region of a surface-to-be-heated.

The present disclosure is an infrared welding machine that joins a first member made of resin and a second member made of resin together by heating and melting at least one of an end surface of the first member and an end surface of the second member and then butting and pressing the end surfaces together. This infrared welding machine includes a heating device that heats and melts the at least one end surface, called a surface-to-be-heated, with infrared rays. The heating device includes: a lamp that is disposed so as to face the surface-to-be-heated without coming into contact with the surface-to-be-heated and has a circular shape in cross-section such that the lamp radiates infrared rays in all radially outward directions; an upper-side reflective member that reflects infrared rays radiated from the lamp toward the upper side of the surface-to-be-heated so as to direct the infrared rays toward the surface-to-be-heated; and a lower-side reflective member that reflects infrared rays radiated from the lamp toward the lower side of the surface-to-be-heated so as to direct the infrared rays toward the surface-to-be-heated.

In this configuration, infrared rays radiated from the lamp in all radially outward directions are efficiently collected by the upper-side reflective member and the lower-side reflective member and applied to the surface-to-be-heated of the object-to-be-joined in the form of a homogeneous plane.

Thus, variation in the depth of fusion between an intermediate region and regions on one end side and the other end side of the surface-to-be-heated can be reduced, so that when the end surface of the first member and the end surface of the second member are butted and pressed together after being melted, the entire regions of these end surfaces are evenly joined together.

As a result, the joint strength (also called the tensile strength at the joint) of the first member and the second member can be enhanced, as well as the time taken for heating and melting can be reduced.

In this infrared welding machine, a back-side half-round region that is a region of an outer circumferential surface of the lamp except for a front-side half-round region that directly faces the surface-to-be-heated may be coated with a reflective film that reflects infrared rays radiated from the lamp toward the front-side half-round region.

In this configuration, those of infrared rays radiated from the lamp in all radially outward directions that are radiated toward the back-side half-round region are reflected toward the front-side half-round region by the reflective film.

Thus, almost all the infrared rays radiated from the lamp are efficiently collected and applied to the surface-to-be-heated in the form of a homogeneous plane.

The infrared welding machine may further include: a support part that allows the first member and the second member to be disposed so as to directly face each other; a shifting part that shifts the heating device to an irradiation position in which the heating device irradiates at least one of the end surface of the first member and the end surface of the second member with infrared rays, as well as to a retracted position to which the heating device is removed from the irradiation position; and a pressing part that butts and presses the end surface of the first member and the end surface of the second member together.

This configuration makes it possible to perform the irradiation operation and the pressing operation continuously and quickly when joining the first member and the second member together. This contributes to increasing the operation efficiency and the joining accuracy.

Further, the present disclosure is an infrared welding machine that joins a first cylindrical member made of resin and a second cylindrical member made of resin together by heating and melting at least one of an annular end surface of the first cylindrical member and an annular end surface of the second cylindrical member and then butting and pressing the annular end surfaces together. This infrared welding machine includes a heating device that heats and melts the at least one annular end surface, called a surface-to-be-heated, with infrared rays. The heating device includes: a lamp that is disposed so as to face the surface-to-be-heated from an axial direction without coming into contact with the surface-to-be-heated and has an annular shape with a circular cross-section such that the lamp radiates infrared rays in all radially outward directions; an outside diameter-side reflective member that has a cylindrical shape and reflects infrared rays radiated from the lamp toward the outside diameter side of the surface-to-be-heated so as to direct the infrared rays toward the surface-to-be-heated; and an inside diameter-side reflective member that has a cylindrical shape and reflects infrared rays radiated from the lamp toward the inside diameter side of the surface-to-be-heated so as to direct the infrared rays toward the surface-to-be-heated.

In this configuration, infrared rays radiated from the lamp in all radially outward directions are efficiently collected by the outside diameter-side reflective member and the inside diameter-side reflective member and applied to the surface-to-be-heated of the object-to-be-joined in the form of a homogeneous plane.

Thus, variation in the depth of fusion between an intermediate region and regions on one end side and the other end side of the surface-to-be-heated can be reduced, so that when the annular end surface of the first cylindrical member and the annular end surface of the second cylindrical member are butted and pressed together after being melted, the entire regions of these annular end surfaces are evenly joined together.

As a result, the joint strength (also called the tensile strength at the joint) of the first cylindrical member and the second cylindrical member can be enhanced, as well as the time taken for heating and melting can be reduced.

In this infrared welding machine, a back-side half-round region that is a region of an outer circumferential surface of the lamp except for a front-side half-round region that directly faces the surface-to-be-heated may be coated with a reflective film that reflects infrared rays radiated from the lamp toward the front-side half-round region.

In this configuration, those of infrared rays radiated from the lamp in all radially outward directions that are radiated toward the back-side half-round region are reflected toward the front-side half-round region by the reflective film.

Thus, almost all the infrared rays radiated from the lamp are efficiently collected and applied to the surface-to-be-heated in the form of a homogeneous plane.

The infrared welding machine may further include: a support part that allows the first cylindrical member and the second cylindrical member to be coaxially disposed; a shifting part that shifts the heating device to an irradiation position in which the heating device irradiates at least one of the annular end surface of the first cylindrical member and the annular end surface of the second cylindrical member with infrared rays, as well as to a retracted position to which the heating device is removed from the irradiation position; and a pressing part that butts and presses the annular end surface of the first cylindrical member and the annular end surface of the second cylindrical member together.

This configuration makes it possible to perform the irradiation operation and the pressing operation continuously and quickly when joining the first cylindrical member and the second cylindrical member together. This contributes to increasing the operation efficiency and the joining accuracy.

Further, the present disclosure is an infrared welding machine that joins a first cylindrical member made of resin and a second cylindrical member made of resin together by heating and melting each of an annular end surface of the first cylindrical member and an annular end surface of the second cylindrical member and then butting and pressing the annular end surfaces together. This infrared welding machine includes a heating device that heats and melts each of the annular end surface of the first cylindrical member and the annular end surface of the second cylindrical member with infrared rays. The heating device includes a first unit that heats and melts the annular end surface of the first cylindrical member and a second unit that heats and melts the annular end surface of the second cylindrical member. The first unit includes: a first lamp that is disposed so as to face the annular end surface of the first cylindrical member without coming into contact with the annular end surface of the first cylindrical member and has an annular shape with a circular cross-section such that the first lamp radiates infrared rays in all radially outward directions; a first outside diameter-side reflective member that reflects infrared rays radiated from the first lamp toward an outside diameter side beyond the annular end surface of the first cylindrical member so as to direct the infrared rays toward the annular end surface of the first cylindrical member; and a first inside diameter-side reflective member that reflects infrared rays radiated from the first lamp toward an inside diameter side beyond the annular end surface of the first cylindrical member so as to direct the infrared rays toward the annular end surface of the first cylindrical member. The second unit includes: a second lamp that is disposed so as to face the annular end surface of the second cylindrical member without coming into contact with the annular end surface of the second cylindrical member and has an annular shape with a circular cross-section such that the second lamp radiates infrared rays in all radially outward directions; a second outside diameter-side reflective member that reflects infrared rays radiated from the second lamp toward an outside diameter side beyond the annular end surface of the second cylindrical member so as to direct the infrared rays toward the annular end surface of the second cylindrical member; and a second inside diameter-side reflective member that reflects infrared rays radiated from the second lamp toward an inside diameter side beyond the annular end surface of the second cylindrical member so as to direct the infrared rays toward the annular end surface of the second cylindrical member.

In this configuration, infrared rays radiated from the first lamp in all radially outward directions are efficiently collected by the first outside diameter-side reflective member and the first inside diameter-side reflective member and applied to the annular end surface of the first cylindrical member in the form of a homogeneous plane.

Meanwhile, infrared rays radiated from the second lamp in all radially outward directions are efficiently collected by the second outside diameter-side reflective member and the second inside diameter-side reflective member and applied to the annular end surface of the second cylindrical member in the form of a homogeneous plane.

Thus, variation in the depth of fusion between an intermediate region and regions on one end side and the other end side of the annular end surface of each of the first and second cylindrical members can be reduced, so that when the annular end surface of the first cylindrical member and the annular end surface of the second cylindrical member are butted and pressed together after being melted, the entire regions of these annular end surfaces are evenly joined together.

As a result, the joint strength of the first cylindrical member and the second cylindrical member can be enhanced, as well as the time taken for heating and melting can be reduced.

In this infrared welding machine, a back-side half-round region that is a region of an outer circumferential surface of each of the first and second lamps except for a front-side half-round region that directly faces the annular end surface of the first or second cylindrical member may be coated with a reflective film that reflects infrared rays radiated from the first or second lamp toward the front-side half-round region.

In this configuration, those of infrared rays radiated from the first and second lamps in all radially outward directions that are radiated toward the back-side half-round regions are reflected toward the front-side half-round regions by the reflective films.

Thus, almost all the infrared rays radiated from the first lamp are efficiently collected and applied to the annular end surface of the first cylindrical member in the form of a homogeneous plane, while almost all the infrared rays radiated from the second lamp are efficiently collected and applied to the annular end surface of the second cylindrical member in the form of a homogeneous plane.

The infrared welding machine may further include: a support part that allows the first cylindrical member and the second cylindrical member to be coaxially disposed; a shifting part that shifts the heating device to an irradiation position in which the heating device irradiates the annular end surface of the first cylindrical member and the annular end surface of the second cylindrical member with infrared rays, as well as to a retracted position to which the heating device is removed from the irradiation position; and a pressing part that butts and presses the annular end surface of the first cylindrical member and the annular end surface of the second cylindrical member together.

This configuration makes it possible to perform the irradiation operation and the pressing operation continuously and quickly when joining the first cylindrical member and the second cylindrical member together. This contributes to increasing the operation efficiency and the joining accuracy.

The present disclosure can provide an infrared welding machine that can evenly and quickly melt the entire region of a surface-to-be-heated.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view showing a schematic configuration of one embodiment of an infrared welding machine according to the present disclosure;

FIG. 2 is a sectional view showing heating devices of FIG. 1; and

FIG. 3 is view showing a close-up of a part of FIG. 2.

### DETAILED DESCRIPTION OF EMBODIMENTS

The best mode for carrying out the present disclosure will be described in detail below with reference to the accompanying drawings.

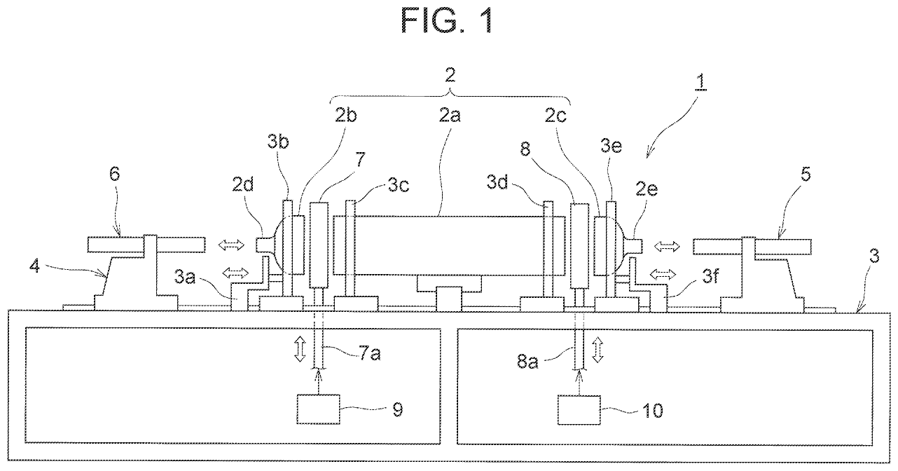

FIG. 1 to FIG. 3 show one embodiment of the present disclosure. Of these drawings, FIG. 1 shows an entire infrared welding machine.

This infrared welding machine 1 has a configuration that is suitable, for example, for joining three constituent elements (a center pipe 2a, a first liner 2b, and a second liner 2c) of a hollow container 2 having a three-piece structure together.

The center pipe 2a, the first liner 2b, and the second liner 2c that are the objects-to-be-joined correspond to the first member, the second member, the first cylindrical member, and the second cylindrical member described in the claims.

Before the infrared welding machine 1 is described in detail, a schematic configuration of the hollow container 2 will be described.

The hollow container 2 is, for example, a high-pressure tank that is used to store hydrogen etc. used for an in-vehicle fuel cell system.

The hollow container 2 includes the center pipe 2a that has a cylindrical shape and is disposed at the center, a first liner 2b that has a shape of a cylinder closed on one side and is joined to one end side of the center pipe 2a in an axial direction (e.g., the left side in FIG. 1), and a second liner 2c that has a shape of a cylinder closed on one end and is joined to the other end side of the center pipe 2a in the axial direction (e.g., the right side in FIG. 1).

The center pipe 2a, the first liner 2b, and the second liner 2c are made of, for example, polyamide resin, called by the trade name nylon.

At an outer end of the first liner 2b and an outer end of the second liner 2c, a cap 2d for mounting a nozzle for supplying contents and a cap 2e for mounting a nozzle for discharging contents are mounted.

When the hollow container 2 is a high-pressure tank as described above, to enhance the pressure resistance, an outer shell (not shown) is formed so as to cover outer circumferences of the center pipe 2a, the first liner 2b, and the second liner 2c after an annular end surface of the first liner 2b is joined to an annular end surface of the center pipe 2a on the left side (one end side) and an annular end surface of the second liner 2c is joined to an annular end surface of the center pipe 2a on the right side (the other end side).

The outer shell is made of fiber-reinforced plastic that is produced by impregnating reinforcing fibers, such as carbon fibers, with thermosetting resin, such as epoxy resin.

Next, the infrared welding machine 1 will be described in detail.

For example, as shown in FIG. 1, the infrared welding machine 1 includes a base 3, a slider 4, a bearer 5, a pressure source 6, two heating devices 7, 8, two lifting units 9, 10, etc.

On the base 3, clamps 3a to 3f that support the objects-to-be-joined (the center pipe 2a, the first liner 2b, and the second liner 2c) are slidably placed. The base 3 and the clamps 3a to 3f correspond to the support part described in the claims.

The slider 4 slides the clamps 3a to 3f over the base 3.

The bearer 5 bears the outer end (the discharge nozzle mounting cap 2e) of the second liner 2c when joining the objects-to-be-joined together.

The pressure source 6 presses the first liner 2b toward the bearer 5 when joining the objects-to-be-joined together.

The pressure source 6 is configured using an electric motor, for example. Although this is not shown in detail, the pressure source 6 is fixed to the slider 4 in a horizontal posture and disposed such that a leading end of a pressing part comes into contact with the outer end (the supply nozzle mounting cap 2d) of the first liner 2b.

The slider 4, the bearer 5, and the pressure source 6 correspond to the pressing part described in the claims.

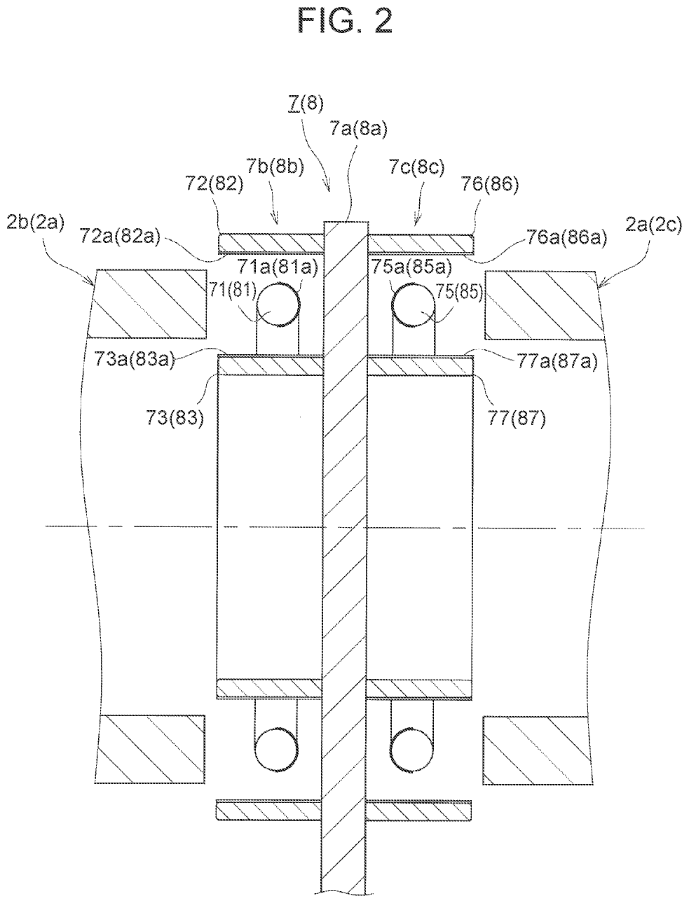

As will be described in detail later, the two heating devices 7, 8 have the same configuration and include, for example, as shown in FIG. 2, support plates 7a, 8a, first units 7b, 8b, and second units 7c, 8c.

The two lifting units 9, 10 move the heating devices 7, 8 up and down along a vertical direction.

Specifically, the lifting units 9, 10 move first lamps 71, 81 and second lamps 75, 85 up to an irradiation position in which these lamps face surfaces-to-be-heated of the objects-to-be-joined (the center pipe 2a, the first liner 2b, and the second liner 2c) at a distance of a predetermined dimension (see the state of FIG. 1), and move these lamps down to a retracted position (not shown) to which these lamps are removed from the irradiation position toward a lower side.

Although this is not shown in detail, the lifting units 9, 10 can be configured by combining, for example, an electric motor, a gear power transmission mechanism or a belt power transmission mechanism, and others, or by using, for example, a hydraulic cylinder or an air cylinder. The lifting units 9, 10 correspond to the shifting part described in the claims.

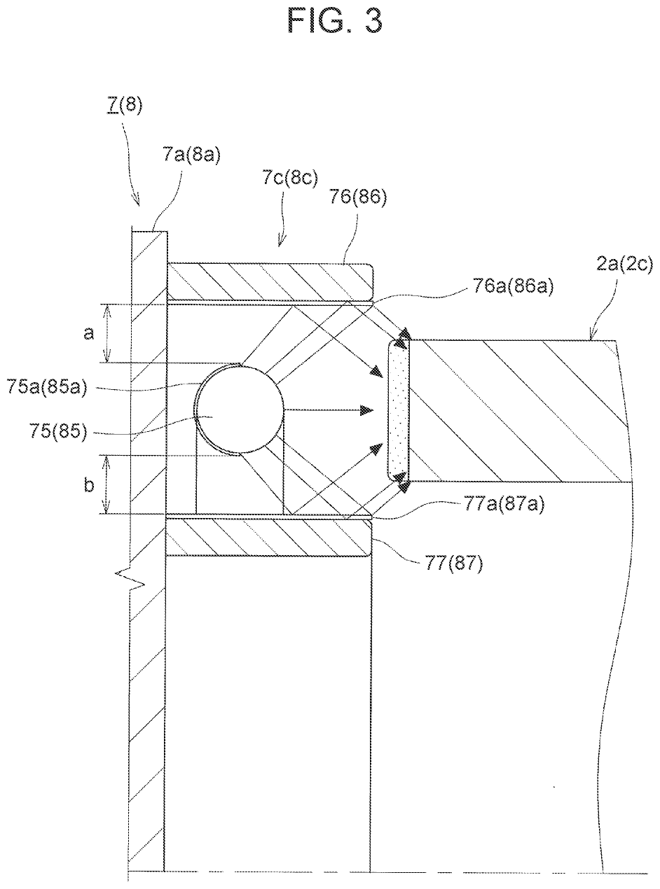

Next, the configuration of the two heating devices 7, 8 will be described in detail with reference to FIG. 2 and FIG. 3.

In the left and right heating devices 7, 8, the first units 7b, 8b are disposed on the left side of the support plates 7a, 8a, and the second units 7c, 8c are disposed on the right side of the support plates 7a, 8a.

The support plates 7a, 8a are disposed such that a plate thickness direction thereof lies along central axes of the first lamps 71, 81 and the second lamps 75, 85 (see FIG. 2).

Elements (71 to 73, 81 to 83) composing the first units 7b, 8b are mounted on one side of the support plates 7a, 8a (e.g., the left side in FIG. 2). Elements (75 to 77, 85 to 87) composing the second units 7c, 8c are mounted on the other side of the support plates 7a, 8a (e.g., the right side in FIG. 2).

The first unit 7b of the left heating device 7 is used to heat and melt the annular end surface of the first liner 2b. The first unit 8b of the right heating device 8 is used to heat and melt the right annular end surface of the center pipe 2a.

The second unit 7c of the left heating device 7 is used to heat and melt the left annular end surface of the center pipe 2a. The second unit 8c of the right heating device 8 is used to heat and melt the annular end surface of the second liner 2c.

The two first units 7b, 8b include the first lamps 71, 81, first outside diameter-side reflective members 72, 82, and first inside diameter-side reflective members 73, 83.

The two second units 7c, 8c include the second lamps 75, 85, second outside diameter-side reflective members 76, 86, and second inside diameter-side reflective members 77, 87.

The first lamps 71, 81 and the second lamps 75, 85 have an annular shape with a circular cross-section, and radiate infrared rays in all radially outward directions (in the direction of each phase in a circumferential direction, or 360 degrees).

Specifically, although this is not shown in detail, the first lamps 71, 81 and the second lamps 75, 85 have a commonly known configuration in which a filament is housed in a glass tube, and radiate infrared rays from the glass tube in all radially outward directions as a current is applied to the filament by a power source (not shown).

Back-side half-round regions that are regions of outer circumferential surfaces of the first lamps 71, 81 and the second lamps 75, 85 except for front-side half-round regions that directly face the surfaces-to-be-heated are coated with reflective films 71a, 81a, 75a, 85a that reflect infrared rays radiated from the first lamps 71, 81 and the second lamps 75, 85 toward the front-side half-round regions.

Specifically, right half-round regions of the first lamps 71, 81 (on the side of the support plates 7a, 8a) and left half-round regions of the second lamps 75, 85 (on the side of the support plates 7a, 8a) are coated with the reflective films 71a, 81a, 75a, 85a. The reflective films 71a, 81a, 75a, 85a are, for example, ceramic films.

The reflective films 71a, 81a of the first lamps 71, 81 reflect those of infrared rays radiated from the first lamps 71, 81 in all radially outward directions that are radiated toward the right half-round regions of the first lamps 71, 81 so as to direct those infrared rays toward left half-round regions of the first lamps 71, 81.

The reflective films 75a, 85a of the second lamps 75, 85 reflect those of infrared rays radiated from the second lamps 75, 85 in all radially outward directions that are radiated toward the left half-round regions of the second lamps 75, 85 so as to direct those infrared rays toward right half-round regions of the second lamps 75, 85.

The first outside diameter-side reflective members 72, 82 are disposed on the left side of the support plates 7a, 8a and have a cylindrical shape, and inner circumferential surfaces thereof are coated with reflective films 72a, 82a that reflect infrared rays.

The first outside diameter-side reflective member 72 of the left heating device 7 reflects infrared rays radiated from the first lamp 71 toward an outside diameter side beyond the annular end surface of the first liner 2b so as to direct those infrared rays toward the annular end surface.

The first outside diameter-side reflective member 82 of the right heating device 8 reflects infrared rays radiated from the first lamp 81 toward an outside diameter side beyond the right annular end surface of the center pipe 2a so as to direct those infrared rays toward the annular end surface.

The first inside diameter-side reflective members 73, 83 are disposed on the left side of the support plates 7a, 8a and have a cylindrical shape, and outer circumferential surfaces thereof are coated with reflective films 73a, 83a that reflect infrared rays.

The first inside diameter-side reflective member 73 of the left heating device 7 reflects infrared rays radiated from the first lamp 71 toward an inside diameter side beyond the annular end surface of the first liner 2b so as to direct those infrared rays toward the annular end surface.

The first inside diameter-side reflective member 83 of the right heating device 8 reflects infrared rays radiated from the first lamp 81 toward an inside diameter side beyond the right annular end surface of the center pipe 2a so as to direct those infrared rays toward the annular end surface.

The second outside diameter-side reflective members 76, 86 are disposed on the right side of the support plates 7a, 8a and have a cylindrical shape, and inner circumferential surfaces thereof are coated with reflective films 76a, 86a that reflect infrared rays.

The second outside diameter-side reflective member 76 of the left heating device 7 reflects infrared rays radiated from the second lamp 75 toward an outside diameter side beyond the left annular end surface of the center pipe 2a so as to direct those infrared rays toward the annular end surface.

The second outside diameter-side reflective member 86 of the right heating device 8 reflects infrared rays radiated from the second lamp 85 toward an outside diameter side beyond the annular end surface of the second liner 2c so as to direct those infrared rays toward the annular end surface.

The second inside diameter-side reflective members 77, 87 are disposed on the right side of the support plates 7a, 8a and have a cylindrical shape, and outer circumferential surfaces thereof are coated with reflective films 77a, 87a that reflect infrared rays.

The second inside diameter-side reflective member 77 of the left heating device 7 reflects infrared rays radiated from the second lamp 75 toward an inside diameter side beyond the left annular end surface of the center pipe 2a so as to direct those infrared rays toward the annular end surface.

The second inside diameter-side reflective member 87 of the right heating device 8 reflects infrared rays that are radiated from the second lamp 85 toward an inside diameter side beyond the annular end surface of the second liner 2c so as to direct those infrared rays toward the annular end surface.

The first outside diameter-side reflective members 72, 82, the first inside diameter-side reflective members 73, 83, the second outside diameter-side reflective members 76, 86, and the second inside diameter-side reflective members 77, 87 are made of, for example, stainless steel (SUS) or aluminum alloy. The reflective films 72a, 82a, 73a, 83a, 76a, 86a, 77a, 87a are, for example, metal plating films or hard-chrome plating films.

For example, as shown in FIG. 3, in the second units 7c, 8c, the second outside diameter-side reflective members 76, 86 are disposed on an outside diameter side of the second lamps 75, 85 at the distance of a predetermined dimension a, and the second inside diameter-side reflective members 77, 87 are disposed on an inside diameter side of the second lamps 75, 85 at the distance of a predetermined dimension b. Here, the distance dimensions a, b are equal.

Although this is not shown, similarly, in the first units 7b, 8b, the first outside diameter-side reflective members 72, 82 are disposed on an outside diameter side of the first lamps 71, 81 at the distance of a predetermined dimension, and the first inside diameter-side reflective members 73, 83 are disposed on an inside diameter side of the first lamps 71, 81 at the distance of a predetermined dimension. Here, as with the distance dimensions a, b, these distance dimensions are equal.

Next, the procedure and operation of joining the first liner 2b and the second liner 2c to the center pipe 2a using the infrared welding machine 1 will be described.

First, as shown in FIG. 1, the center pipe 2a, the first liner 2b, and the second liner 2c are supported by the clamps 3a to 3f so as to be coaxially disposed. The annular end surface of the center pipe 2a on the left side (one end side) and the annular end surface of the first liner 2b are placed face-to-face at the distance of a predetermined dimension, while the annular end surface of the center pipe 2a on the right side (the other end side) and the annular end surface of the second liner 2c are placed face-to-face at the distance of a predetermined dimension.

Then, the left heating device 7 is disposed by the left lifting unit 9 in a space across which the left annular end surface of the center pipe 2a and the annular end surface of the first liner 2b face each other (irradiation position), while the right heating device 8 is disposed by the right lifting unit 10 in a space across which the right annular end surface of the center pipe 2a and the annular end surface of the second liner 2c face each other (irradiation position).

At this point, positional relationships between the elements (71 to 73, 81 to 83) of the first units 7b, 8b and the surfaces-to-be-heated of the objects-to-be-joined (2b, 2a), and positional relationships between the elements (75 to 77, 85 to 87) of the second units 7c, 8c and the surfaces-to-be-heated of the objects-to-be-joined (2a, 2c) are set as shown in FIG. 2 and FIG. 3.

After this preparation is made, infrared rays are radiated from the first lamps 71, 81 and the second lamps 75, 85 of the two heating devices 7, 8.

In this case, those of infrared rays radiated from the first lamps 71, 81 in all radially outward directions that are radiated toward the right half-round regions are reflected toward the left half-round regions by the reflective films 71a, 81a. Moreover, infrared rays radiated from the first lamps 71, 81 toward the outside diameter side are reflected toward the surfaces-to-be-heated by the first outside diameter-side reflective members 72, 82, while infrared rays radiated from the first lamps 71, 81 toward the inside diameter side are reflected toward the surfaces-to-be-heated by the first inside diameter-side reflective members 73, 83. Thus, almost all the infrared rays radiated from the first lamps 71, 81 are efficiently collected and applied to the surfaces-to-be-heated (the annular end surface of the first liner 2b and the right annular end surface of the center pipe 2a) in the form of a homogeneous plane.

Meanwhile, those of infrared rays radiated from the second lamps 75, 85 in all radially outward directions that are radiated toward the left half-round regions are reflected toward the right half-round regions by the reflective films 75a, 85a. Moreover, infrared rays radiated from the second lamps 75, 85 toward the outside diameter side are reflected toward the surfaces-to-be-heated by the second outside diameter-side reflective members 76, 86, while infrared rays radiated from the second lamps 75, 85 toward the inside diameter side are reflected toward the surfaces-to-be-heated by the second inside diameter-side reflective members 77, 87. Thus, almost all the infrared rays radiated from the second lamps 75, 85 are efficiently collected and applied to the surfaces-to-be-heated (the left annular end surface of the center pipe 2a and the annular end surface of the second liner 2c) in the form of a homogeneous plane.

Executing this heating and melting process for a predetermined time can reduce the variation in the depth of fusion between an intermediate region in the radial direction and regions on one end side and the other end side in the radial direction of each annular end surface.

After the predetermined time has elapsed, the heating devices 7, 8 are moved down by the lifting units 9, 10 to dispose the heating devices 7, 8 in the retracted position.

Subsequently, the first liner 2b, the center pipe 2a, and the second liner 2c are moved by the slider 4 so as to be thrust against the bearer 5. Then, by the pressure source 6, the annular end surface of the first liner 2b is pressed against the left annular end surface of the center pipe 2a while the right annular end surface of the center pipe 2a is pressed against the annular end surface of the second liner 2c.

As a result, the annular end surface of the first liner 2b is joined to the annular end surface of the center pipe 2a on the left side (one end side) while the annular end surface of the second liner 2c is joined to the annular end surface of the center pipe 2a on the right side (the other end side), and thus a hollow container 2 is produced.

It is preferable that conditions in the above-described operation (the butting speed, pressure to be applied, pressing time, etc.) be adjusted as necessary to optimal values that have been learned from experience.

As has been described above, according to the embodiment to which the present disclosure is applied, infrared rays radiated from the first lamps 71, 81 in all radially outward directions can be efficiently collected by the reflective films 71a, 81a of the first lamps 71, 81, the first outside diameter-side reflective members 72, 82, and the first inside diameter-side reflective members 73, 83 and applied to the surfaces-to-be-heated (the annular end surfaces) of the objects-to-be-joined (the center pipe 2a, the first liner 2b, and the second liner 2c) in the form of a homogeneous plane.

Meanwhile, infrared rays radiated from the second lamps 75, 85 in all radially outward directions can be efficiently collected by the reflective films 75a, 85a of the second lamps 75, 85, the second outside diameter-side reflective members 76, 86, and the second inside diameter-side reflective members 77, 87 and applied to the surfaces-to-be-heated of the objects-to-be-joined in the form of a homogeneous plane.

Thus, variation in the depth of fusion between an intermediate region and regions on one end side and the other end side of each surface-to-be-heated can be reduced, so that when the surfaces-to-be-heated of the objects-to-be-joined are butted and pressed together after being melt, the entire regions of these surfaces-to-be-heated are evenly joined together.

Therefore, the joint strength of the objects-to-be-joined (the center pipe 2a, the first liner 2b, and the second liner 2c) can be enhanced, as well as the time taken for heating and melting can be reduced. The time taken for joining can be reduced accordingly.

The present disclosure is not limited to the above embodiment alone but can be changed as necessary within the scope of the claims and a scope equivalent to that scope.

(1) The above embodiment shows an example in which the infrared welding machine 1 has a configuration including two heating devices 7, 8, but the present disclosure is not limited to this example alone.

Although this is not shown, the infrared welding machine 1 according to the present disclosure may have, for example, a configuration including one heating device.

This configuration is suitable for joining two objects-to-be-joined together.

(2) The above embodiment shows an example in which the heating devices 7, 8 have a configuration including both the first units 7b, 8b and the second units 7c, 8c, but the present disclosure is not limited to this example alone.

Although this is not shown, the heating devices 7, 8 may have, for example, a configuration including only either the first units 7b, 8b or the second units 7c, 8c.

When this configuration is adopted, the annular end surface of the first liner 2b can be joined to the annular end surface of the center pipe 2a on the left side (one end side), and the annular end surface of the second liner 2c can be joined to the annular end surface of the center pipe 2a on the right side (the other end side), as follows: Only either the left annular end surface of the center pipe 2a or the annular end surface of the first liner 2b is heated and melted, while only either the right annular end surface of the center pipe 2a or the annular end surface of the second liner 2c is heated and melted, and then the heated and melted annular end surfaces are butted and pressed against the annular end surfaces that have not been heated and melted.

(3) When the configuration of the heating devices 7, 8 that includes only either the first units 7b, 8b or the second units 7c, 8c as described in (2) is adopted, although this is not shown, the axial dimensions of a single outside diameter-side reflective member and a single inside diameter-side reflective member can be set to larger dimensions, and a single lamp can be disposed at the center in the axial direction of a space across which the outside diameter-side reflective member and the inside diameter-side reflective member face each other. Thus, formation of a reflective film on the lamp can be omitted.

When this configuration is adopted, the annular end surface of the first liner 2b can be joined to the annular end surface of the center pipe 2a on the left side (one end side), and the annular end surface of the second liner 2c can be joined to the annular end surface of the center pipe 2a on the right side (the other end side), as follows: The left annular end surface of the center pipe 2a and the annular end surface of the first liner 2b are heated and melted at the same time, while the right annular end surface of the center pipe 2a and the annular end surface of the second liner 2c are heated and melted at the same time, and then these annular end surfaces are butted and pressed together.

(4) The above embodiment shows an example in which the annular end surface of the first liner 2b of the hollow container 2 is joined to the annular end surface of the center pipe 2a thereof on the left side (one end side), and the annular end surface of the second liner 2c thereof is joined to the annular end surface of the center pipe 2a on the right side (the other side). However, the present disclosure is not limited to this example alone.

Although this is not shown, the object-to-be-joined may be, for example, an intake manifold having a two-piece or three-piece structure. In this case, the present disclosure can be applied to joining constituent elements of the intake manifold together.

Further, the object-to-be-joined is not limited to cylindrical members, and the present disclosure can also be applied to joining end surfaces of members of arbitrary shapes, such as rod-shaped members or plate-shaped members, together.

The present disclosure can be suitably used as an infrared welding machine that joins a first member made of resin and a second member made of resin together by heating and melting at least one of an end surface of the first member and an end surface of the second member and then butting and pressing the end surfaces together.

What is claimed is:

1. An infrared welding machine that joins a first member made of resin and a second member made of resin together by heating and melting at least one of an end surface of the first member and an end surface of the second member and then butting and pressing the end surfaces together,
the infrared welding machine comprising a heating device that heats and melts the at least one end surface, called a surface-to-be-heated, with infrared rays,
the heating device including:
a lamp that is disposed so as to face the surface-to-be-heated without coming into contact with the surface-to-be-heated and has a circular shape in cross-section such that the lamp radiates infrared rays in all radially outward directions;
an upper-side reflective member that reflects infrared rays radiated from the lamp toward an upper side of the surface-to-be-heated so as to direct the infrared rays toward the surface-to-be-heated; and
a lower-side reflective member that reflects infrared rays radiated from the lamp toward a lower side of the surface-to-be-heated so as to direct the infrared rays toward the surface-to-be-heated.

2. The infrared welding machine according to claim 1, wherein a back-side half-round region that is a region of an outer circumferential surface of the lamp except for a front-side half-round region that directly faces the surface-to-be-heated is coated with a reflective film that reflects infrared rays radiated from the lamp toward the front-side half-round region.

3. The infrared welding machine according to claim 1, further comprising:
a support part that allows the first member and the second member to be disposed so as to directly face each other;
a shifting part that shifts the heating device to an irradiation position in which the heating device irradiates at least one of the end surface of the first member and the end surface of the second member with infrared rays, as well as to a retracted position to which the heating device is removed from the irradiation position; and
a pressing part that butts and presses the end surface of the first member and the end surface of the second member together.

4. An infrared welding machine that joins a first cylindrical member made of resin and a second cylindrical member made of resin together by heating and melting at least one of an annular end surface of the first cylindrical member and an annular end surface of the second cylindrical member and then butting and pressing the annular end surfaces together,
the infrared welding machine comprising a heating device that heats and melts the at least one annular end surface, called a surface-to-be-heated, with infrared rays,
the heating device including:
a lamp that is disposed so as to face the surface-to-be-heated from an axial direction without coming into contact with the surface-to-be-heated and has an annular shape with a circular cross-section such that the lamp radiates infrared rays in all radially outward directions;
an outside diameter-side reflective member that has a cylindrical shape and reflects infrared rays radiated from the lamp toward an outside diameter side of the surface-to-be-heated so as to direct the infrared rays toward the surface-to-be-heated; and
an inside diameter-side reflective member that has a cylindrical shape and reflects infrared rays radiated from the lamp toward an inside diameter side of the surface-to-be-heated so as to direct the infrared rays toward the surface-to-be-heated.

5. The infrared welding machine according to claim 4, wherein a back-side half-round region that is a region of an outer circumferential surface of the lamp except for a front-side half-round region that directly faces the surface-to-be-heated is coated with a reflective film that reflects infrared rays radiated from the lamp toward the front-side half-round region.

6. The infrared welding machine according to claim 4, further comprising:
a support part that allows the first cylindrical member and the second cylindrical member to be coaxially disposed;
a shifting part that shifts the heating device to an irradiation position in which the heating device irradiates at least one of the annular end surface of the first cylindrical member and the annular end surface of the second cylindrical member with infrared rays, as well as to a retracted position to which the heating device is removed from the irradiation position; and
a pressing part that butts and presses the annular end surface of the first cylindrical member and the annular end surface of the second cylindrical member together.

7. An infrared welding machine that joins a first cylindrical member made of resin and a second cylindrical member made of resin together by heating and melting each of an annular end surface of the first cylindrical member and an annular end surface of the second cylindrical member and then butting and pressing the annular end surfaces together,
the infrared welding machine comprising a heating device that heats and melts each of the annular end surface of the first cylindrical member and the annular end surface of the second cylindrical member with infrared rays,
the heating device including a first unit that heats and melts the annular end surface of the first cylindrical member and a second unit that heats and melts the annular end surface of the second cylindrical member,
the first unit including:
a first lamp that is disposed so as to face the annular end surface of the first cylindrical member without coming into contact with the annular end surface of the first cylindrical member and has an annular shape with a circular cross-section such that the first lamp radiates infrared rays in all radially outward directions;
a first outside diameter-side reflective member that reflects infrared rays radiated from the first lamp toward an outside diameter side beyond the annular end surface of the first cylindrical member so as to direct the infrared rays toward the annular end surface of the first cylindrical member; and
a first inside diameter-side reflective member that reflects infrared rays radiated from the first lamp toward an inside diameter side beyond the annular end surface of the first cylindrical member so as to direct the infrared rays toward the annular end surface of the first cylindrical member,
the second unit including:
a second lamp that is disposed so as to face the annular end surface of the second cylindrical member without coming into contact with the annular end surface of the second cylindrical member and has an annular shape with a circular cross-section such that the second lamp radiates infrared rays in all radially outward directions;
a second outside diameter-side reflective member that reflects infrared rays radiated from the second lamp toward an outside diameter side beyond the annular end surface of the second cylindrical member so as to direct the infrared rays toward the annular end surface of the second cylindrical member; and
a second inside diameter-side reflective member that reflects infrared rays radiated from the second lamp toward an inside diameter side beyond the annular end surface of the second cylindrical member so as to direct the infrared rays toward the annular end surface of the second cylindrical member.

8. The infrared welding machine according to claim 7, wherein a back-side half-round region that is a region of an outer circumferential surface of each of the first and second lamps except for a front-side half-round region that directly faces the annular end surface of the first or second cylindrical member is coated with a reflective film that reflects infrared rays radiated from the first or second lamp toward the front-side half-round region.

9. The infrared welding machine according to claim 7, further comprising:
a support part that allows the first cylindrical member and the second cylindrical member to be coaxially disposed;
a shifting part that shifts the heating device to an irradiation position in which the heating device irradiates the annular end surface of the first cylindrical member and the annular end surface of the second cylindrical member with infrared rays, as well as to a retracted position to which the heating device is removed from the irradiation position; and
a pressing part that butts and presses the annular end surface of the first cylindrical member and the annular end surface of the second cylindrical member together.
